(19) United States
(12) Patent Application Publication
(10) Pub. No.: US 2015/0045911 A1
(43) Pub. Date: Feb. 12, 2015

(54) INDUSTRIAL MACHINE SYSTEM AND TRANSMISSION/RECEPTION SYSTEM

(71) Applicant: MURATA MACHINERY, LTD., Kyoto-shi (JP)

(72) Inventor: Takanori SAKAMOTO, Kyoto (JP)

(21) Appl. No.: 14/446,367

(22) Filed: Jul. 30, 2014

(30) Foreign Application Priority Data
Aug. 12, 2013 (JP) 2013-167493

(51) Int. Cl. G05B 15/02; H04W 4/00

(52) U.S. Cl. CPC G05B 15/02; H04W 4/005
USPC 700/11

(57) ABSTRACT

An industrial machine system includes an instruction device, a relay machine, and an industrial machine. The instruction device is configured to wirelessly transmit to the relay machine such that an instruction signal includes a regulation release signal that releases regulation of drive of the industrial machine or a regulation non-release signal that regulates the drive of the industrial machine, and a drive signal. The relay machine is configured to generate a control signal that corresponds to the instruction signal and to transmit the control signal to the industrial machine, when detecting that wireless communication is disconnected, the relay machine generates the control signal that corresponds to the regulation non-release signal and transmits the control signal to the industrial machine.

### CROSS-REFERENCE TO RELATED APPLICATIONS

This application claims priority under 35 U.S.C. 119 to Japanese Patent Application No. 2013-167493, filed on Aug. 12, 2013, which application is hereby incorporated by reference in its entirety.

### BACKGROUND OF THE INVENTION

1. Field of the Invention

The present invention relates to an industrial machine, and in particular, a system in which the industrial machine is operated by use of wireless communication.

2. Description of the Related Art

Conventionally, various types of the industrial machines such as a machine tool, a textile machine, a transportation machine, and the like are widely used in a manufacturing facility and the like. The industrial machines often need to be adjusted before use.

For example, a lathe, which is one of the industrial machines, is mounted with a loader that automatically carries a work to a processing machine. A position of the loader is required to be finely adjusted before an automatic operation.

Fine adjustment is required also in a case of creating an operation program for automation.

Conventionally, the adjustment is performed by use of a wired instruction device (wired remote control) that is connected to the lathe. The wired instruction device is an instruction device including a rotary switch capable of switching a control axis, and a pulse encoder capable of moving the position of the loader.

However, the wired instruction device inconveniently has a feature in which a field of activities is limited by a connecting wire, a feature in which care should be taken to handle the wire, or the like. Recently, a wireless introduction device therefore is used to resolve the features in some cases.

The wireless instruction device is used in combination with a relay machine. The relay machine is configured to receive a wireless signal transmitted from the wireless instruction device and to transmit a control signal, based on the wireless signal, to an industrial machine to be controlled. In addition, the relay machine is configured to feed back to the wireless instruction device, a signal transmitted from the industrial machine to be controlled.

When using the wireless instruction device, wireless communication between the wireless instruction device and the relay machine may be disconnected depending on communication environments.

The signal transmitted from the wireless instruction device includes information that an operation button of an enable switch is being pressed, or the like. The enable switch is a switch that prevents an unexpected operation of the machine, and as long as the operation button is pressed, regulation of drive of the industrial machine is released.

At this point, there is considered a case where the wireless communication is disconnected while the signal including the information that the operation button of the enable switch is being pressed is transmitted from the wireless instruction device. In this case, since even if the pressing of the operation button of the enable switch is interrupted while the wireless communication is disconnected, a signal indicating that the pressing of the operation button is interrupted is not received by the relay machine, the relay machine may recognize that the operation button of the enable switch is being pressed. In the case of using the wireless instruction device, therefore, there is a problem in which the industrial machine may perform the unexpected operation when the wireless communication is disconnected.

In a conventional wireless instruction device and a conventional controller for an automatic machine, to solve the above-described problems, the automatic machine is stopped by the controller when disconnection of wireless communication is detected.

However, the conventional controller employs a configuration in which a special signal other than a drive instruction signal is output when disconnection of the wireless communication is detected. In the conventional wireless instruction device and the conventional controller, therefore, there is a problem in which configuration thereof is complicated.

### SUMMARY OF THE INVENTION

Preferred embodiments of the present invention prevent unexpected or undesired operation of an industrial machine in a system in which the industrial machine is operated by wireless communication.

An industrial machine system according to a preferred embodiment of the present invention includes an instruction device, a relay machine, and an industrial machine. The instruction device includes a regulation signal generating unit configured to generate a regulation release signal that releases regulation of drive of the industrial machine or a regulation non-release signal that regulates the drive of the industrial machine, a drive signal generating unit configured to generate a drive signal that instructs the drive of the industrial machine, and an instruction device communication unit configured to wirelessly transmit to the relay machine, an instruction signal having the regulation release signal or the regulation non-release signal, and the drive signal. The industrial machine includes a drive mechanism unit, and a drive control unit configured and programmed to control the drive mechanism unit. The relay machine is configured to receive the instruction signal wirelessly transmitted from the instruction device communication unit, to generate a control signal that corresponds to the instruction signal, and to transmit the control signal to the drive control unit. When receiving the control signal that corresponds to the regulation release signal, the drive control unit is configured to perform drive of the drive mechanism unit based on the drive signal, and when receiving the control signal that corresponds to the regulation non-release signal from the relay machine, the drive control unit is configured not to perform the drive of the drive mechanism unit based on the drive signal. When detecting that wireless communication between the instruction device communication unit and the relay machine is disconnected, the relay machine is configured to generate the control signal that corresponds to the regulation non-release signal and to transmit the control signal to the drive control unit.

With such a configuration, when the wireless communication is disconnected, an unexpected operation of the industrial machine is prevented. Furthermore, since a signal used in the system corresponds to an operation of an enable switch and is not a special signal, the above-described effect is achieved without causing a configuration of the industrial machine system to be complicated. In addition, since the relay machine according to the present preferred embodiment of the present invention does not transmit the special signal to the industrial machine, when the relay machine according to the present preferred embodiment of the present invention is connected instead of a wired instruction device of a conventional industrial machine, the industrial machine is not required to be converted.

In the industrial machine system according to a preferred embodiment of the present invention, the drive mechanism unit includes a plurality of drive modes having a disable mode that disables the drive signal. When the relay machine detects that the wireless communication between the instruction device communication unit and the relay machine is disconnected, the drive mechanism unit preferably is set to the disable mode.

With such a configuration, the drive of the industrial machine is stopped, and thus the unexpected operation of the industrial machine is reliably prevented.

In the industrial machine system according to a preferred embodiment of the present invention, the drive signal includes a drive mode signal that specifies one mode of the plurality of drive modes. When the drive mechanism unit is in the disable mode, on a condition of receiving the control signal that corresponds to the regulation release signal, the drive control unit is configured and programmed to control the drive mechanism unit such that the drive mode of the drive mechanism unit is brought into the drive mode specified by the drive mode signal.

With such a configuration, the unexpected operation of the industrial machine when the wireless communication is resumed is prevented.

In the industrial machine system according to a preferred embodiment of the present invention, when detecting that the wireless communication between the instruction device communication unit and the relay machine is disconnected, the relay machine may wirelessly transmit to the instruction device communication unit, a signal indicating that the drive mechanism unit has been stopped.

With such a configuration, an operator can know via the instruction device that the industrial machine has been stopped by the disconnection of the wireless communication.

A transmission/reception system according to a preferred embodiment of the present invention is a transmission/reception system configured to remotely operate an industrial machine, and includes an instruction device and a relay machine. The instruction device includes a regulation signal generating unit configured to generate a regulation release signal that releases regulation of drive of the industrial machine or a regulation non-release signal that regulates the drive of the industrial machine, a drive signal generating unit configured to generate a drive signal that instructs the drive of the industrial machine, and an instruction device communication unit configured to wirelessly transmit to the relay machine, an instruction signal having the regulation release signal or the regulation non-release signal, and the drive signal. The relay machine is configured to receive the instruction signal wirelessly transmitted from the instruction device communication unit, to generate a control signal that corresponds to the instruction signal, and to transmit the control signal to the industrial machine. When detecting that wireless communication between the instruction device communication unit and the relay machine is disconnected, the relay machine is configured to generate the control signal that corresponds to the regulation non-release signal and to transmit the control signal to the industrial machine.

With such a configuration, the transmission/reception system prevents an unexpected operation of the industrial machine when the wireless communication is disconnected.

In the transmission/reception system according to a preferred embodiment of the present invention, when detecting that the wireless communication between the instruction device communication unit and the relay machine is disconnected, the relay machine preferably wirelessly transmits to the instruction device communication unit, a signal indicating that the industrial machine has been stopped.

With such a configuration, an operator can know via the instruction device that the industrial machine has been stopped by the disconnection of the wireless communication.

The various preferred embodiments of the present invention can be realized not only as a device, but as a method in which processing measures performed by a device are provided as steps. In addition, the various preferred embodiments of the present invention may be realized as a non-transitory computer readable medium containing a computer program configured to cause a computer to perform the steps of the method. Furthermore, the various preferred embodiments of the present invention may be realized as information of the computer program, data or a signal. The program, the information, the data, and the signal may be delivered via a communication network such as internet.

With the various preferred embodiments of the present invention, in a system in which the industrial machine is operated by wireless communication, when the wireless communication is disconnected, the unexpected operation of the industrial machine is prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating a configuration of an industrial machine system according to a preferred embodiment of the present invention.

FIG. 2 is a block diagram illustrating a functional configuration of an instruction device according to a preferred embodiment of the present invention.

FIG. 3 is an external view of one specific example of the instruction device according to a preferred embodiment of the present invention.

FIG. 4 is a block diagram illustrating a functional configuration of a relay machine according to a preferred embodiment of the present invention.

FIG. 5 is a block diagram illustrating a functional configuration of the industrial machine according to a preferred embodiment of the present invention.

FIG. 6 is a flowchart illustrating operations of the industrial machine system according to a preferred embodiment of the present invention.

FIG. 7 is a diagram illustrating state transitions of the industrial machine according to a preferred embodiment of the present invention.

### DETAILED DESCRIPTION OF THE PREFERRED EMBODIMENTS

It is to be noted that each of the preferred embodiments described below illustrates a preferable specific example of the present invention. Numerical values, shapes, materials, components, arranged positions of the components, connection forms, steps, orders of the steps, and the like described in the following preferred embodiments are merely examples, and it should therefore not be construed that the present invention is limited thereto. Accordingly, out of the components in the following preferred embodiments, the components not stated in the independent claims describing the broadest concept of the present invention will be described as arbitrary components forming more preferable preferred embodiments.

The same reference numerals are assigned to the same components, and description may be omitted.

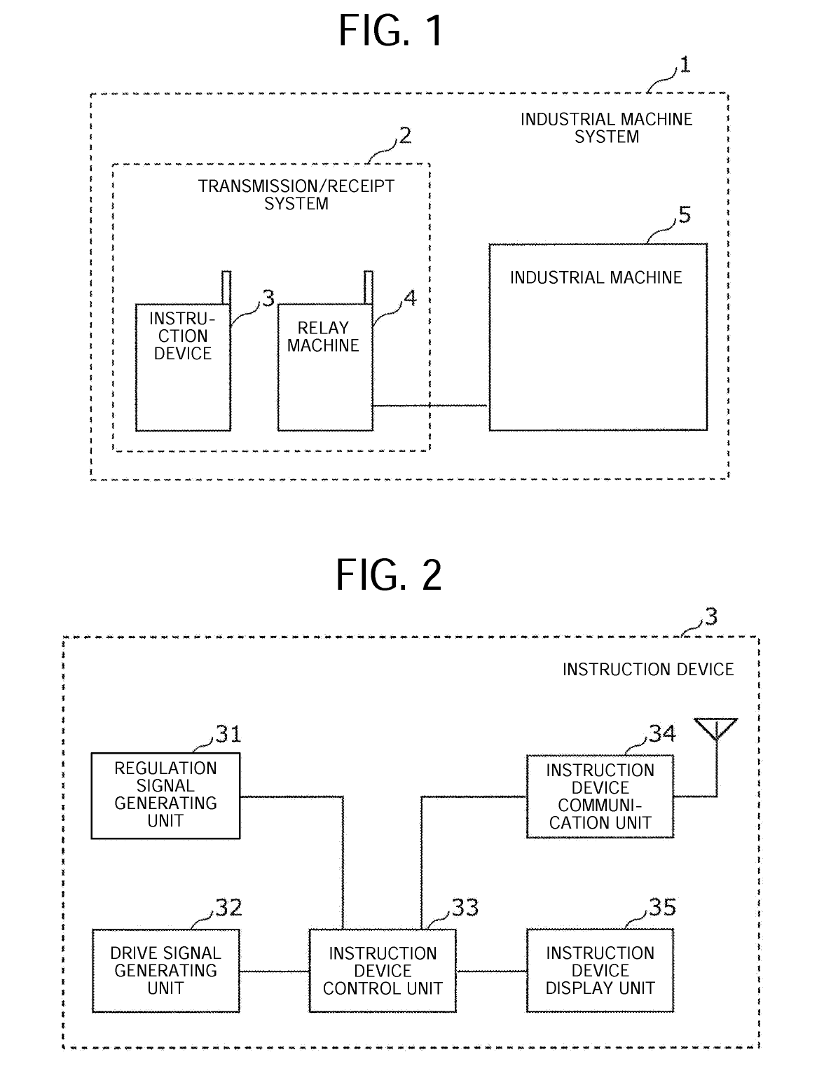

FIG. 1 is a diagram illustrating a configuration of an industrial machine system 1 according to a preferred embodiment of the present invention.

As illustrated in FIG. 1, the industrial machine system 1 includes a transmission/reception system 2 and an industrial machine 5. The transmission/reception system 2 includes an instruction device 3 and a relay machine 4.

FIG. 2 is a block diagram illustrating a functional configuration of the instruction device 3 of FIG. 1.

As illustrated in FIG. 2, the instruction device 3 includes a regulation signal generating unit 31, a drive signal generating unit 32, an instruction device control unit 33, an instruction device communication unit 34 and an instruction device display unit 35, and is configured to wirelessly transmit an instruction signal to the relay machine 4 based on an operation of an operator.

The regulation signal generating unit 31 is a signal generating unit configured, based on an operation of the operator, to generate a regulation signal. The regulation signal includes a regulation release signal that releases regulation of drive of the industrial machine 5 or a regulation non-release signal that regulates the drive of the industrial machine 5. The regulation release signal is called an “enable signal” and the regulation non-release signal is called a “disable signal” hereinafter. The regulation signal generating unit 31 outputs the regulation signal to the instruction device control unit 33. In other words, the regulation signal generating unit 31 defines and functions as an enable switch.

The drive signal generating unit 32 is a signal generating unit configured, based on an operation of the operator, to generate a drive signal that instructs the drive of the industrial machine 5 and to output the drive signal to the instruction device control unit 33.

The instruction device control unit 33 is a processing unit configured and programmed to receive the regulation signal and the drive signal respectively from the regulation signal generating unit 31 and the drive signal generating unit 32, and to transmit an instruction signal including the regulation signal and the drive signal to the instruction device communication unit 34. In addition, based on a signal transmitted from the relay machine 4 and received by the instruction device communication unit 34, the instruction device control unit 33 transmits a signal to the instruction device display unit 35.

The instruction device communication unit 34 is a wireless communication unit configured to wirelessly transmit to the relay machine 4, the instruction signal transmitted from the instruction device control unit 33. In addition, the instruction device communication unit 34 is configured to receive a wireless signal transmitted from the relay machine 4 and transmit the wireless signal to the instruction device control unit 33. A protocol used in wireless communication is not limited in particular, but for example, a UDP (User Datagram Protocol) and the like may be used.

The instruction device display unit 35 is a display unit configured to display a state of the industrial machine 5 based on the signal transmitted from the relay machine 4.

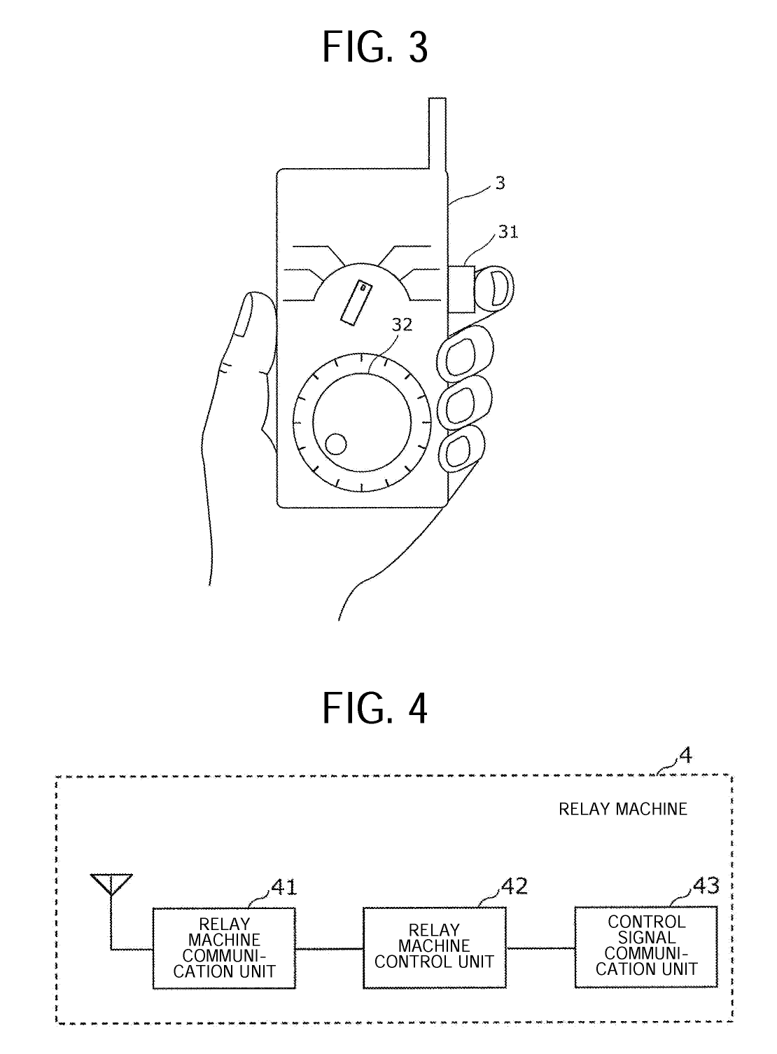

FIG. 3 is an external view illustrating one specific example of the instruction device 3 of FIG. 1.

In the example illustrated in FIG. 3, the regulation signal generating unit 31 includes a press button and is arranged such that the operator can press the press button with operator's finger while gripping the instruction device 3. The regulation signal including the enable signal and the regulation signal including the disable signal are output from the regulation signal generating unit 31 respectively in a case where the operator presses the press button and in a case where the operator does not press the press button.

FIG. 4 is a block diagram illustrating a functional configuration of the relay machine 4 of FIG. 1.

As illustrated in FIG. 4, the relay machine 4 includes a relay machine communication unit 41, a relay machine control unit 42 and a control signal communication unit 43. The relay machine 4 is configured to receive the instruction signal wirelessly transmitted from the instruction device 3 and to transmit a control signal that controls the drive of the industrial machine 5.

The relay machine communication unit 41 is a wireless communication unit configured to receive the instruction signal wirelessly transmitted from the instruction device communication unit 34 and to transmit the instruction signal to the relay machine control unit 42. In addition, the relay machine communication unit 41 wirelessly transmits the signal indicating a state of the industrial machine 5 to the instruction device 3.

The relay machine control unit 42 is a processing unit configured and programmed to generate a control signal based on the instruction signal transmitted from the relay machine communication unit 41 and to transmit the control signal to the control signal communication unit 43.

The control signal communication unit 43 is a communication unit configured to transmit the control signal generated by the relay machine control unit 42 to the industrial machine 5.

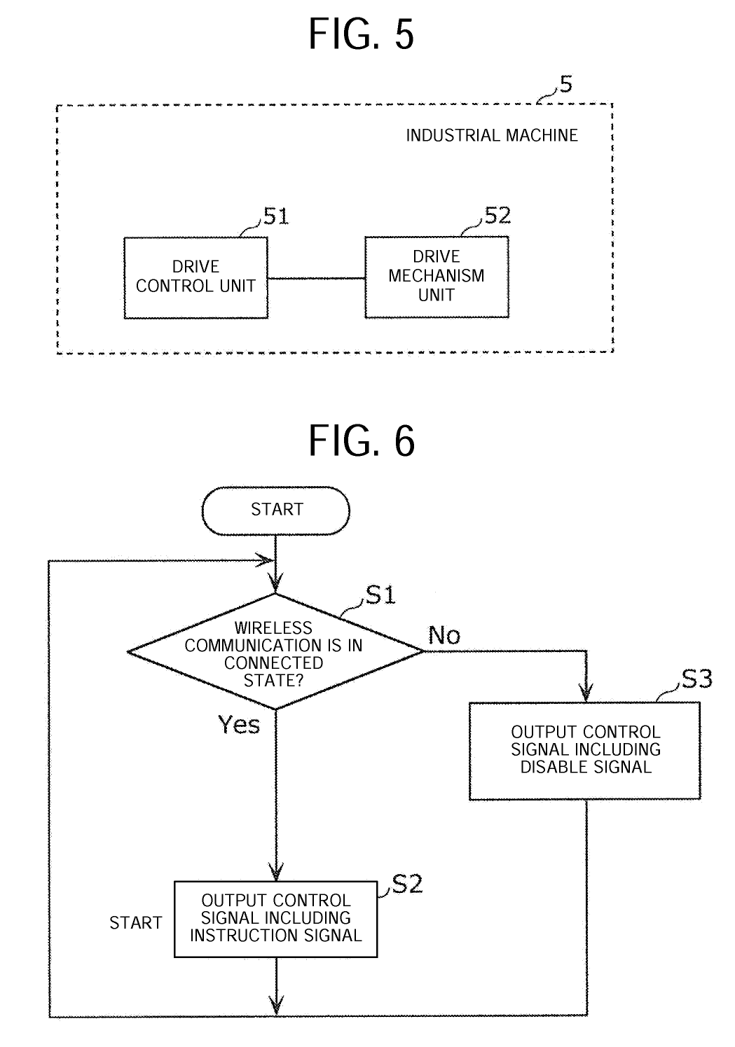

FIG. 5 is a block diagram illustrating a functional configuration of the industrial machine 5 of FIG. 1.

As illustrated in FIG. 5, the industrial machine 5 includes a drive control unit 51 and a drive mechanism unit 52, and is configured to be driven based on the control signal transmitted from the relay machine 4. The industrial machine 5 is not limited in particular, and may be a machine tool, a textile machine, a transportation machine, and the like.

The drive control unit 51 is a processing unit configured and programmed to control drive of the drive mechanism unit 52 based on the control signal transmitted from the control signal communication unit 43 of the relay machine 4.

The drive mechanism unit 52 is a mechanism unit configured to be driven based on a signal transmitted from the drive control unit 51.

Next, operations of the industrial machine system 1 will be described.

FIG. 6 is a flowchart illustrating an outline of the operations of the relay machine 4.

When an operation of the relay machine 4 is started, based on the instruction signal received by the relay machine communication unit 41 of the relay machine 4, the relay machine control unit 42 determines whether or not wireless communication between the instruction device communication unit 34 of the instruction device 3 and the relay machine communication unit 41 are in a connected state (S1).

When determining that the wireless communication is in the connected state, the relay machine control unit 42 transmits the control signal including the instruction signal, which has been received by the relay machine communication unit 41, from the control signal communication unit 43 to the drive control unit 51 of the industrial machine 5 (S2).

When determining that the wireless communication is not in the connected state (the wireless communication is disconnected), the relay machine control unit 42 generates a control signal including the disable signal and transmits the control signal from the control signal communication unit 43 to the drive control unit 51 of the industrial machine 5 (S3).

When step S2 or S3 is completed, the relay machine control unit 42 returns to step S1 and repeats the above-described operations.

Now, the operations of the industrial machine system 1 in each step of the above-described operations will be described in detail.

One example of a process in step S1 to determine whether or not the wireless communication is in the connected state will be described.

In a case where the UDP is used as the protocol of the wireless communication, the instruction device communication unit 34 transmits an instruction signal sequence over a repetition cycle that preferably is about 100 msec, for example.

When the relay machine communication unit 41 confirms receipt of the instruction signal sequence wirelessly transmitted from the instruction device communication unit 34, the relay machine control unit 42 determines that the wireless communication between the instruction device communication unit 34 and the relay machine communication unit 41 are in the connected state.

On the other hand, when a state in which the relay machine communication unit 41 cannot confirm the receipt of the instruction signal continues for a predetermined or more period of time, the relay machine control unit 42 determines that the wireless communication between the instruction device communication unit 34 and the relay machine communication unit 41 is not in the connected state. The predetermined period of time is decided with the repetition cycle of the instruction signal sequence, specifications of the industrial machine 5, and the like. To prevent an unexpected operation of the industrial machine 5, the predetermined period of time is preferably shorter, and may be within about 10 seconds, for example, or more preferably within about 3 seconds.

In step S2, the instruction signal wirelessly transmitted from the instruction device 3 is transmitted to the drive control unit 51 of the industrial machine 5 via the relay machine 4. Then, the drive control unit 51 controls the drive of the drive mechanism unit 52 in accordance with the instruction signal.

In step S3, the relay machine communication unit 41 does not receive the instruction signal wirelessly transmitted from the instruction device 3. The relay machine control unit 42 therefore, upon the determination in step S1 that the wireless communication is not in the connected state, generates the control signal including the disable signal and causes the control signal communication unit 43 to transmit the control signal including the disable signal. Upon receipt of the control signal, the drive control unit 51 transmits the signal that regulates the drive to the drive mechanism unit 52 to stop the drive of the drive mechanism unit 52.

In such a manner, the unexpected operation of the industrial machine 5 is prevented in a case where the wireless communication is disconnected.

Furthermore, in step S3, to provide notification to the instruction device 3 that the regulation signal is not received, the relay machine control unit 42 causes the relay machine communication unit 41 to transmit a signal indicating that the drive mechanism unit 52 of the industrial machine 5 has been stopped. When the instruction device communication unit 34 receives the signal, the instruction device control unit 33 brings the instruction device display unit 35 into a display state indicating that the drive mechanism unit 52 of the industrial machine 5 has been stopped. By seeing the display state of the instruction device display unit 35, the operator of the instruction device 3 can know of the disconnection of the wireless communication.

Next, state transitions of the industrial machine 5 in the industrial machine system 1 will be described.

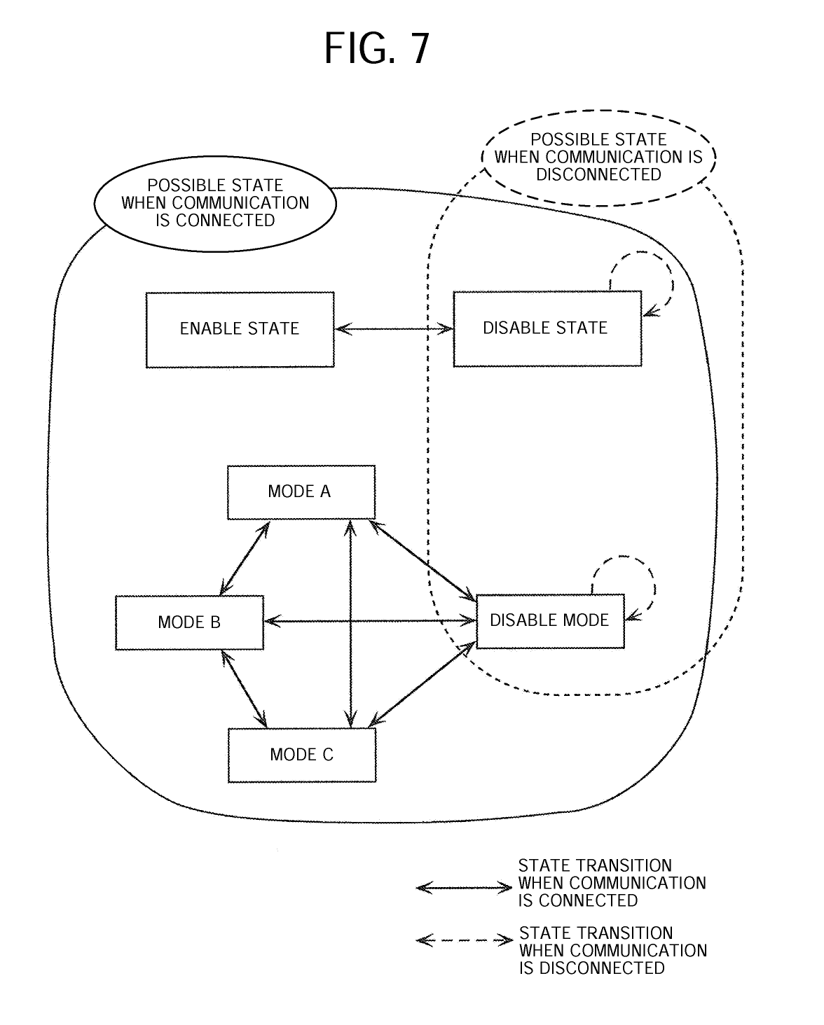

FIG. 7 is a diagram illustrating the state transitions of the industrial machine 5 in the industrial machine system 1.

In FIG. 7, each state surrounded by a solid line represents a possible state of the industrial machine 5 in the case where the wireless communication is in the connected state, and each state surrounded by a dotted line represents a possible state of the industrial machine 5 in the case where the wireless communication is disconnected.

In FIG. 7, solid-line arrows indicate possible state transitions of the industrial machine 5 in the case where the wireless communication is in the connected state, and dashed-line arrows indicate possible state transitions of the industrial machine 5 in the case where the wireless communication is disconnected.

Now, each state of FIG. 7 will be described.

An enable state and a disable state are states the drive control unit 51 assumes respectively in a case of receiving the control signal including the enable signal and in a case of receiving the control signal including the disable signal. In the enable state, regulation of the drive of the industrial machine 5 is released and thus the industrial machine 5 can be driven. In the disable state, the drive of the industrial machine 5 is regulated and thus the industrial machine 5 cannot be driven.

Each industrial machine 5 has drive modes A to C. The drive modes may include, for example, a drive mode in a direction of each drive axis x, y, and z, an origin returning mode for moving the drive mechanism unit 52 to an original position, and the like. FIG. 7 illustrates the three modes A to C, but a number of such drive modes varies according to each industrial machine 5, and not limited to three.

An disable mode is a mode that disables the drive signal received from the instruction device 3. The disable mode stops the drive mechanism unit 52.

Now, transitions between the states in FIG. 7 will be described.

As illustrated in FIG. 7, in the case where the wireless communication is in the connected state, transitions between the states of the industrial machine 5 are possible. In other words, based on the regulation signal included in the instruction signal transmitted from the instruction device 3, the industrial machine 5 is brought into the enable state or the disable state, and based on the drive signal included in the instruction signal, the industrial machine 5 transitions to any one of the drive modes.

The drive signal includes a drive mode signal that specifies one of a plurality of the drive modes. Based on the drive mode signal, the drive control unit 51 of the industrial machine 5 causes the drive mechanism unit 52 to transition to a specified drive mode.

On the other hand, in the case where the wireless communication is disconnected, the transitions of the industrial machine 5 from the disable state and from the disable mode are regulated. In other words, as described above, in the case where the wireless communication is disconnected, the control signal including the disable signal is transmitted from the control signal communication unit 43 of the relay machine 4 to the drive control unit 51 of the industrial machine 5, and the industrial machine 5 is brought into the disable state. In this case, the drive control unit 51 brings the industrial machine 5 into the disable state and transmits a signal to the drive mechanism unit 52 to make the drive mode to the disable mode. Accordingly, irrespective of a state before the wireless communication is disconnected, in the case where the wireless communication is disconnected, the industrial machine 5 is brought into the disable mode and the drive of the drive mechanism unit 52 is stopped.

In a case where the wireless communication is brought into the connected state from the disconnected state, the instruction signal including the drive signal output from the drive signal generating unit 32 of the instruction device 3 is transmitted by wireless communication to the relay machine 4, then to the drive control unit 51 of the industrial machine 5. When the wireless communication is in the disconnected state, as described above, the industrial machine 5 is in the disable mode, but when the wireless communication is brought into the connected state and the drive control unit 51 of the industrial machine 5 receives the enable signal, the industrial machine 5 transitions to the drive mode indicated by the drive signal.

By causing the industrial machine 5 to operate in a manner as described above, when the wireless communication is resumed, the industrial machine 5 is not driven until the operator operates the regulation signal generating unit 31. An operation of the industrial machine 5 that is not intended by the operator thus is prevented.

Since the industrial machine system 1 of the present preferred embodiment is configured as described above, in the case where the wireless communication is disconnected, an unexpected operation of the industrial machine 5 is prevented.

For example, as a specific example, in the above-described origin returning mode, operations of the industrial machine system 1 in the case where the wireless communication is disconnected will be described.

When a drive signal that indicates the origin returning mode is output from the drive signal generating unit 32 of the instruction device 3, and the enable signal is output from the regulation signal generating unit 31, the industrial machine 5 starts an origin returning operation. At this time, when the wireless communication is disconnected before the origin returning operation of the industrial machine 5 is completed, even if the operator causes the instruction device 3 to output the disable signal to interrupt the origin returning operation by operating the regulation signal generating unit 31, the relay machine 4 cannot receive the disable signal.

Therefore, in a conventional system, when the wireless communication is disconnected, even if the regulation signal generating unit 31 is operated, the origin returning operation is not interrupted in some cases. Furthermore, a situation may occur in which the operator instructs a next drive without noticing that the origin returning operation is not interrupted.

However, in the present preferred embodiment, since in a case where the wireless communication is disconnected during the origin returning operation, the industrial machine 5 receives the control signal including the disable signal from the relay machine 4, the industrial machine 5 is brought into the disable state and transitions from the origin returning mode to the disable mode. The drive of the industrial machine 5 is thus stopped. In addition, since with the signal transmitted from the relay machine 4, the instruction device display unit 35 is brought into a display state indicating that the industrial machine 5 has been stopped, the operator can know that the industrial machine 5 has been stopped.

As described above, when detecting that the wireless communication is disconnected, the industrial machine system 1 according to the present preferred embodiment transmits the control signal including the disable signal to the drive control unit 51 of the industrial machine 5. Accordingly, the unexpected operation of the industrial machine 5 is prevented. In addition, since the above-described control signal corresponds to an operation of the enable switch and is not a special signal, without causing a configuration of the industrial machine system 1 to be complicated, the above-described effects are achieved. Furthermore, since the relay machine 4 according to the present preferred embodiment does not transmit a special signal to the industrial machine 5, when connecting the relay machine 4 according to the present preferred embodiment instead of a conventional wired instruction device of the industrial machine, the industrial machine is not required to be converted.

With the industrial machine system 1 according to the present preferred embodiment, when detecting that the wireless communication is disconnected, the industrial machine 5 is brought into the disable mode. Accordingly, the drive of the industrial machine 5 is stopped and thus the unexpected operation of the industrial machine 5 is reliably prevented.

With the industrial machine system 1 according to the present preferred embodiment, when the wireless communication is resumed, the industrial machine 5 is maintained in the disable mode until the industrial machine 5 receives the control signal including the enable signal. Accordingly, the unexpected operation of the industrial machine 5 when the wireless communication is resumed is prevented.

With the industrial machine system 1 according to the present preferred embodiment, when detecting that the wireless communication is disconnected, the relay machine 4 wirelessly transmits to the instruction device 3, the signal indicating that the industrial machine 5 has been stopped. Accordingly, since the instruction device display unit 35 of the instructing device 3 is brought into the display state indicating that the industrial machine 5 has been stopped, the operator can know that the industrial machine 5 has been stopped by the disconnection of the wireless communication.

The industrial machine system 1 of the present invention has been described based on the preferred embodiments, but the present invention is not limited to the present preferred embodiments. Various modifications of the exemplary preferred embodiment as well as preferred embodiments resulting from arbitrary combinations of structural elements of different exemplary preferred embodiments that may be conceived by those skilled in the art may also be included within the scope according to the aspects of the present invention as long as these do not depart from the essence of the present invention.

For example, in the above-described preferred embodiments, a configuration is preferably adopted in which the relay machine 4 and the industrial machine 5 are bodies separated from each other, but the preferred embodiments of the present invention are not limited thereto, and the relay machine 4 and the industrial machine 5 may be configured as one body.

In the above-described preferred embodiments, a configuration is preferably adopted in which the drive of the drive mechanism unit 52 of the industrial machine 5 is stopped in a case of the disable mode, but the preferred embodiments of the present invention are not limited thereto. For example, in a case of using an industrial machine 5 that can be in a dangerous state when the drive of the drive mechanism unit 52 is immediately stopped upon the disconnection of the wireless communication, the industrial machine 5 may be driven in a safe driven state upon the disconnection of the wireless communication.

In the above-described preferred embodiments, a configuration is preferably adopted in which the regulation signal is a signal itself that is output from the regulation signal generating unit 31, but the preferred embodiments of the present invention are not limited thereto. Any configuration may be used in which the regulation signal is generated based on the signal output from the regulation signal generating unit 31.

In the above-described preferred embodiments, a configuration is preferably adopted in which the drive signal is a signal itself that is output from the drive signal generating unit 32, but the preferred embodiments of the present invention are not limited thereto. Any configuration may be used in which the drive signal is generated based on the signal output from the drive signal generating unit 31.

In the above-described preferred embodiments, the control signal preferably includes the instruction signal, but the preferred embodiments of the present invention are not limited thereto. The control signal may not include the instruction signal itself, and any control signal that includes a signal corresponding to the instruction signal may be used.

The various preferred embodiments of the present invention may be applied to a system in which an industrial machine is operated by wireless communication.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An industrial machine system comprising:
an instruction device;
a relay machine; and
an industrial machine; wherein
the instruction device includes:
a regulation signal generating unit configured to generate a regulation release signal that releases regulation of drive of the industrial machine or a regulation non-release signal that regulates the drive of the industrial machine;
a drive signal generating unit configured to generate a drive signal that instructs the drive of the industrial machine; and
an instruction device communication unit configured to wirelessly transmit to the relay machine, an instruction signal having the regulation release signal or the regulation non-release signal, and the drive signal;
the industrial machine includes:
a drive mechanism unit; and
a drive control unit configured and programmed to control the drive mechanism unit; wherein
the relay machine is configured to receive the instruction signal wirelessly transmitted from the instruction device communication unit, to generate a control signal that corresponds to the instruction signal, and to transmit the control signal to the drive control unit;
when receiving the control signal that corresponds to the regulation release signal, the drive control unit is configured and programmed to perform drive of the drive mechanism unit based on the drive signal, and when receiving the control signal that corresponds to the regulation non-release signal from the relay machine, the drive control unit is configured and programmed not to perform the drive of the drive mechanism unit based on the drive signal; and
when detecting that wireless communication between the instruction device communication unit and the relay machine is disconnected, the relay machine is configured to generate the control signal that corresponds to the regulation non-release signal and to transmit the control signal to the drive control unit.

2. The industrial machine system according to claim 1, wherein
the drive mechanism unit includes a plurality of drive modes including an disable mode that disables the drive signal; and
when the relay machine detects that the wireless communication between the instruction device communication unit and the relay machine is disconnected, the drive mechanism unit is set to the disable mode.

3. The industrial machine system according to claim 2, wherein
the drive signal includes a drive mode signal that specifies one mode of the plurality of drive modes; and
when the drive mechanism unit is in the disable mode, on a condition of receiving the control signal that corresponds to the regulation release signal, the drive control unit is configured and programmed to control the drive mechanism unit such that the drive mode of the drive mechanism unit is brought into the drive mode specified by the drive mode signal.

4. The industrial machine system according to claim 1, wherein when detecting that the wireless communication between the instruction device communication unit and the relay machine is disconnected, the relay machine is configured to wirelessly transmit to the instruction device communication unit, a signal indicating that the drive mechanism unit has been stopped.

5. A transmission/reception system configured to remotely operate an industrial machine, comprising:
an instruction device; and
a relay machine; wherein
the instruction device includes:
a regulation signal generating unit configured to generate a regulation release signal that releases regulation of drive of the industrial machine or a regulation non-release signal that regulates the drive of the industrial machine;
a drive signal generating unit configured to generate a drive signal that instructs the drive of the industrial machine; and
an instruction device communication unit configured to wirelessly transmit to the relay machine, an instruction signal having the regulation release signal or the regulation non-release signal, and the drive signal; wherein
the relay machine is configured to receive the instruction signal wirelessly transmitted from the instruction device communication unit, to generate a control signal that corresponds to the instruction signal, and to transmit the control signal to the industrial machine; and
when detecting that wireless communication between the instruction device communication unit and the relay machine is disconnected, the relay machine is configured to generate the control signal that corresponds to the regulation non-release signal and to transmit the control signal to the industrial machine.

6. The transmission/reception system according to claim 5, wherein when detecting that the wireless communication between the instruction device communication unit and the relay machine is disconnected, the relay machine is configured to wirelessly transmit to the instruction device communication unit, a signal indicating that the industrial machine has been stopped.
